(19) United States
(12) Patent Application Publication
(10) Pub. No.: US 2026/0037234 A1
(43) Pub. Date: Feb. 5, 2026

(54) Generating Software Code Using Large Language Models

(71) Applicant: Oracle International Corporation, Redwood Shores, CA (US)

(72) Inventor: Vivek Kumar, Redwood City, CA (US)

(73) Assignee: Oracle International Corporation, Redwood Shores, CA (US)

(21) Appl. No.: 18/788,658

(22) Filed: Jul. 30, 2024

(51) Int. Cl. G06F 8/35

(52) U.S. Cl. CPC G06F 8/35

(57) ABSTRACT

Techniques for generating proprietary software code using large language models (LLMs) are disclosed. An LLM is trained on billions of words, tokens, and code segments to generate non-proprietary software code. A system uses the LLM to generate proprietary software code by generating a set of LLM prompts and a proprietary code mapping. Based on receiving an instruction to generate a set of software code, a system generates a set of LLM prompts. The system prompts the LLM to generate a set of non-proprietary software code. The system further prompts the LLM to generate a set of pseudocode from the non-proprietary software code. The system further prompts the LLM to generate proprietary software code from the pseudocode and the proprietary code mapping.

### TECHNICAL FIELD

The present disclosure relates to generating software code using large language models (LLMs). In particular, the present disclosure relates to providing proprietary code mappings to LLMs with instructions for generating code to cause the LLMs to generate proprietary software code.

### BACKGROUND

Large language models (LLMs) are machine learning models trained on billions of words, tokens, and software code segments to generate natural language sentences and software code. LLMs are trained on generic code data. For example, the Internet includes vast quantities of JAVA software code examples. The LLM learns how to generate JAVA software code from these widely used and available software code examples. However, enterprises and other entities may implement proprietary rules and code constructs. These may be used to maintain consistency across an organization, to ensure compatibility with legacy applications, and to ensure readability among software programmers. Since these rules are proprietary to organizations, LLMs are not trained on the proprietary rules. Organizations utilizing proprietary software code are not able to utilize the processing power of LLMs to generate code that complies with the organization's proprietary rules.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for generating proprietary software code using LLMs in accordance with one or more embodiments;

FIGS. 3A and 3B illustrate an example embodiment; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. INTRODUCTION
2. GENERAL OVERVIEW
3. SOFTWARE CODE GENERATION ARCHITECTURE
4. GENERATING SOFTWARE CODE USING LARGE LANGUAGE MODELS
5. EXAMPLE EMBODIMENT
6. COMPUTER NETWORKS AND CLOUD NETWORKS
7. HARDWARE OVERVIEW
8. MISCELLANEOUS; EXTENSIONS

### 1. Introduction

Software code includes proprietary software code and non-proprietary software code. As referred to herein, software code includes code written in a programming language that may be compiled to generate executable software artifacts and programs. Examples of software code include JAVA, PYTHON, and C++. As referred to herein, proprietary software code is software code that adheres to a set of additional rules, restrictions, and/or conventions for generating and modifying software constructs. The additional rules, restrictions, and/or conventions are in addition to the set of rules that characterize the programming language and that every set of software code written in the programming language are required to comply with. Examples of additional rules that characterize proprietary software code include naming conventions for naming data objects, variables, and operations as well as rules for selecting a type of data object to generate or a type of operation to perform. For example, a set of requirements for software code may specify a desired set of results, such as generating a table of values, performing a calculation on the values, and returning a set of values for a corresponding set of variables. A programming language may include three different functions that can generate the table of values and two different functions that could perform the calculation on the values. In addition, the programming language may allow for a nearly infinite number of possible names for naming the set of variables. Proprietary software code specifies one of the functions to generate the table, one of the functions to perform the calculation, and one set of variable names for the set of variables. A set of code that is written to generate the set of variables using any other function for generating the table, any other function for performing the calculation, and any other naming convention for the set of variables is non-proprietary software code.

Programmers generate software code in a programming language based on programming language-agnostic pseudocode. As referred to herein, pseudocode is a high-level description of a computer algorithm that uses natural language to outline the steps of the algorithm. The pseudocode is not tied to any specific programming language syntax. As a result, the pseudocode allows programmers to design and plan algorithms in a human-readable format before translating them into actual code. In some embodiments, pseudocode includes comments to explain steps and constructs included in the pseudocode.

### 2. General Overview

One or more embodiments generate proprietary software code using a large language machine learning model (LLM) that has been trained to generate non-proprietary software code. LLMs are trained with large volumes of data of different types, on the order of billions of words, text segments, programming code segments, and pseudocode segments. The LLM training dataset either does not include proprietary code segments, or the proprietary code segments are too scarce to train the LLM to generate proprietary software code. For example, based on a prompt including a set of pseudocode, the LLM may be trained to generate a set of software code including a most-frequently-used software code construct to execute a required function. However, the rules that characterize proprietary software code may specify a different software code construct to execute the same function. A system generates the proprietary software code using the LLM by prompting the LLM with non-proprietary prompt data and a proprietary code mapping. The proprietary code mapping specifies pairs of non-proprietary software code constructs and proprietary software code constructs. A pair represents a non-proprietary code construct to be replaced with the corresponding proprietary code construct by the LLM. The rules that characterize the proprietary software code may be implemented to maintain consistency, to maintain compatibility with legacy applications, to improve readability of software code, or to achieve any other purpose for an organization.

According to one example, the system prompts the LLM with a set of pseudocode, an instruction to convert the pseudocode to a set of proprietary software code, and a proprietary code mapping of non-proprietary software code constructs to proprietary software code constructs. Examples of software code constructs include statements, functions, variables, operators, objects, properties, methods, and comments.

According to another example, the system prompts the LLM with a set of non-proprietary software code. The prompt further includes an instruction to convert the non-proprietary software code to pseudocode and a proprietary code mapping of non-proprietary pseudocode constructs to proprietary pseudocode constructs. Examples of pseudocode constructs include human-understandable descriptions of functions to be performed by software code and data structures to be generated and used by the software code.

One or more embodiments generate feedback based on code generated by the LLM to iteratively update LLM prompt data. For example, when a system provides the LLM with a prompt to generate proprietary software code as output code based on pseudocode as input code, the prompt may further include an instruction directing the LLM to not guess when generating the output code. For example, if an LLM is trained on a dataset that includes a few or no examples of a particular code construct, the LLM may be poorly trained to generate the code construct. If the LLM receives an instruction to generate the code construct, it would typically “guess” or generate a code construct that it determines, based on the LLM parameters, is most likely to correspond to the code construct. These attempts are frequently wrong, resulting in errors at compile-time or run-time. In one or more embodiments, a system may include in the LLM prompt an instruction to not guess at code constructs that the LLM does not know. As used herein, an LLM may “know” a code construct corresponds to an input prompt based on one or more of a number of examples of the code construct included in a training data set and/or a similarity of training examples to the input prompt and/or the code construct. Examples of such instructions include an express instruction telling the LLM to express uncertainty, an instruction directing the LLM to generate confidence scores for its code constructs, and an instruction to pass input code data through to output code data without generating pseudo- or software code from the input code data. The system uses the expressions of uncertainty generated by the LLM as feedback to update LLM prompts. When the system identifies input code constructs that the LLM was unable to convert into output code constructs, the system (a) identifies output code constructs that correspond to the input code constructs and (b) updates the proprietary code mapping provided to the LLM as input prompt data.

One or more embodiments described in this Specification and/or recited in the claims may not be included in this General Overview section.

### 3. Software Code Generation Architecture

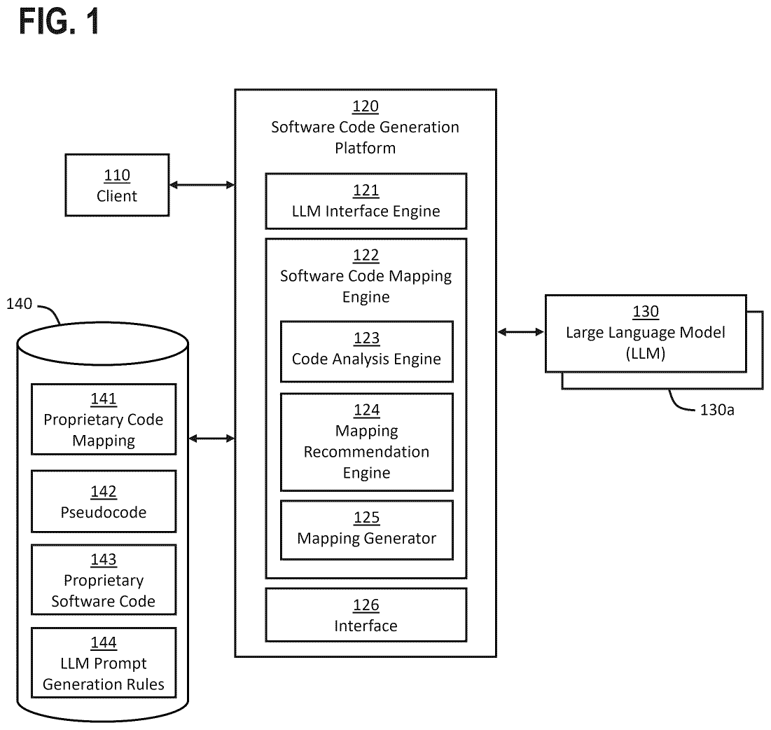

FIG. 1 illustrates a system 100 in accordance with one or more embodiments. As illustrated in FIG. 1, system 100 includes a client device 110, a software code generation platform 120, a large language type machine learning model (LLM), and a data repository 140. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks.”

In one or more embodiments, a data repository 140 is any type of storage unit and/or device (e.g., a file system, database, collection of tables, or any other storage mechanism) for storing data. Furthermore, a data repository 140 may include multiple different storage units and/or devices. The multiple different storage units and/or devices may or may not be of the same type or located at the same physical site. Furthermore, a data repository 140 may be implemented or executed on the same computing system as the software code generation platform 120. Additionally, or alternatively, a data repository 140 may be implemented or executed on a computing system separate from the software code generation platform 120. The data repository 140 may be communicatively coupled to the software code generation platform 120 via a direct connection or via a network.

Information describing a proprietary code mapping 141, pseudocode 142, proprietary software code 143, and LLM prompt generation rules 144 may be implemented across any of components within the system 100. However, this information is illustrated within the data repository 140 for purposes of clarity and explanation.

In one or more embodiments, client device 110 is a tenant in a shared computing environment. A tenant (such as client device 110) is a corporation, organization, enterprise or other entity that accesses a shared computing resource such as the LLM 130. In an embodiment, tenants are independent from each other. A business or operation of one tenant is separate from a business or operation of another tenant.

In one or more embodiments, the LLM is a type of deep learning model that combines a deep learning technique, called attention, with a deep learning model type, known as transformers, to build predictive models. These predictive models encode and predict natural language writing. LLM 130 contains hundreds of billions of parameters trained on multiple terabytes of text. LLM 130 is trained to receive natural language as an input. LLMs typically generate natural language as an output. In addition, LLM 130 is trained to output computer code. LLM 130 is made up of layers of attention mechanisms and neural networks that process input data in parallel. The layers of attention mechanisms and neural networks operating in parallel allow the LLM 130 to learn complex patterns in text and code.

The attention mechanisms help neural networks to learn the context of words in the sequences of words. In the LLM 130, the attention mechanisms help neural networks to learn the context of words, symbols, and other tokens in computer code among sequences of computer code. An attention mechanism operates by breaking down a set of input data, such as a sentence or sequence of words or tokens, into keys, queries, and values. Keys represent elements of the input data that provide information about what to pay attention to. Queries represent elements of the input data that need to be compared with the keys to determine relevance. Values are elements of the input data that will be selected or weighted based on the attention scores. The attention mechanism calculates a similarity score between each query and key pair. This score reflects how relevant a key is to a given query. Various methods can be used to compute these scores, such as dot-product, scaled dot-product, or other custom functions. The similarity scores are then transformed into attention weights. For example, a system may transform the similarity scores using a softmax function. The softmax function adjusts the values of the similarity scores relative to each other such that the sum of the similarity scores is 1. Finally, the attention weights are used to take a weighted sum of the corresponding values. This weighted sum represents the model's focused or “attended” representation of the input data. In one or more embodiments, the attention mechanisms are implemented using self-attention processes, scaled dot-product attention processes, and multi-head attention processes.

In an operation, the LLM 130 receives a natural language prompt as input data and generates a sequence of words in natural language by predicting a next word, or sequence of words, based on the textual and grammatical patterns learned by the LLM during training. In addition, the LLM 130 receives a natural language prompt as input data and generates a sequence of tokens in computer code (such as pseudocode or software code) by predicting a next token, or sequence of tokens, based on the computer code patterns learned by the LLM during training.

A software code generation platform 120 utilizes a trained LLM 130 to generate software code based on receiving instructions from a user via a client device 110. In one example, a user provides to the software code generation platform 120 a set of requirements. The requirements may be in natural language. The natural language may exclude pseudocode and software code. For example, a natural language instruction may take the following form: “Generate a set of C++ code that receives a file as input data, parses the file to identify numerical values, stores the numerical values in a table with the following headings . . . , and generates a sum for each column of the table. The code should comply with XYZ programming requirements.” Additionally, or alternatively, the client device 110 may provide a set of pseudocode 142 to the software code generation platform 120 with an instruction to generate software code from the € 8 pseudocode. In one or more embodiments, the software code generation platform 120 generates proprietary software code 143 by providing the LLM 130 with a set of non-proprietary pseudocode 142 and a proprietary code mapping 141.

An LLM interface engine 121 generates LLM prompts to instruct the LLM 130 to generate output code and presents the output code to the client device 110. The LLM interface engine 121 may generate graphical user interface (GUI) data to present in a display of the interface 126. The GUI data may include interface elements to allow a user to provide a request to an LLM 130. For example, the GUI data may include a text entry field to receive a user-generated LLM prompt or a user-generated set of requirements for software code to be generated by the LLM 130. Additionally, or alternatively, the GUI data may include data to present selectable icons that allow a user to generate requests and LLM prompts by interacting with the selectable icons using a cursor.

In one or more embodiments, the LLM interface engine 121 interfaces between a client device 110 and an LLM 130. The LLM interface engine 121 modifies and/or supplements user-generated prompts and requests via the client device 110. The modifications to LLM prompts and/or user requests may be performed without user input directing the LLM interface engine 121 to perform the modifications. Additionally, or alternatively, the LLM interface engine 121 may request user confirmation prior to implementing modifications or supplementing the user-generated prompts and requests. In one or more embodiments, modifying a user-generated prompt or request includes converting text transmitted from the client device 110 to the LLM interface engine 121 into an LLM prompt format by applying LLM prompt generation rules 144. For example, if a user accesses the LLM 130 via an application maintained by a tenant in a shared-resources environment, the LLM interface engine 121 may supplement a user-provided LLM prompt with an instruction that the software code generated by the LLM 130 meets a set of rules specified for the tenant. The LLM interface engine 121 may further apply the LLM prompt generation rules 144 to ensure that an LLM prompt includes required elements, such as a clear instruction to generate a set of code and a clear description of the type of code to be generated. Supplementing a user-generated prompt further includes providing a proprietary code mapping 141 to the LLM 130 together with an LLM prompt. For example, if the LLM interface engine 121 identifies a proprietary identifier in a prompt, such as “output the code according to XYZ Co. programming requirements,” the LLM interface engine 121 may retrieve the corresponding proprietary code mapping 141 from the repository 140 to attach to the prompt.

In one or more embodiments, the LLM interface engine 121 parses a request from a client device 110 directed to an LLM 130 to identify different components of the request. The different components may include, for example, a description of an operation or task to be performed by a set of code, a target set of data on which to perform the operation or task, a type of output code, and a proprietary identifier corresponding to a proprietary set of rules and requirements. The proprietary identifier may correspond to a proprietary code mapping 141 of non-proprietary code to proprietary code.

In one or more embodiments, the LLM interface engine 121 initiates multiple prompts to one or more LLMs 130, 130a based on a single user generated request from the client device 110. For example, a user may generate a request to the LLM to “generate a set of JAVA code that receives a file as input data, parses the file to identify numerical values, and stores the numerical values in a table with the following headings . . . . The code should comply with XYZ programming requirements.” The LLM interface engine 121 may initiate a sequence of LLM prompts, including (a) a first prompt to the LLM 130 to generate a set of non-proprietary JAVA code based on the user input, (b) a second prompt to the LLM 130a to generate a set of pseudocode from the non-proprietary JAVA code, and (c) a third prompt to the LLM 130 to generate a set of proprietary JAVA code that complies with XYZ programming requirements. While the above example is implemented with two LLMs 130 and 130a, alternative embodiments provide the prompts (a), (b), and (c) to the same LLM 130.

A software code mapping engine 122 generates a proprietary code mapping 141. A code analysis engine 123 analyzes proprietary code to identify code constructs. The code analysis engine 123 may identify, for example, (a) functions implemented in the code to perform tasks, (b) data objects generated in the code, (c) variables generated, (d) data files accessed, (e) syntax used, (f) comments included in the code, and (g) naming conventions used to name functions, variables, objects, statements. The code analysis engine 123 identifies patterns in the code. For example, the code analysis engine 123 may determine that the code usually names variables in a particular way. The code analysis engine 123 may determine that the code usually uses a particular function to perform a task, where multiple different functions could be used to perform the task.

Based on the patterns identified in the proprietary code by the code analysis engine 123, a proprietary code mapping recommendation engine 124 generates a set of mapping recommendations. The proprietary code mapping recommendations may map non-proprietary code constructs to proprietary code constructs. For example, the proprietary code mapping recommendations may map software code constructs or pseudocode constructs to recommended proprietary software code constructs. The proprietary code mapping recommendation engine 124 may present recommendations via the interface 126 to the client device 110. Additionally, or alternatively, the proprietary code mapping recommendation engine 124 may generate recommended proprietary rules. The rules may include, for example, requirements for naming variables and other data objects, limits on a size of data objects, limits on a size of code constructs, rules specifying when functions may be used with each other, and rules specifying when to include comments among the code.

Based on user input confirming or refusing recommendations, a proprietary code mapping generator 125 generates a proprietary code mapping 141 for a set of analyzed code.

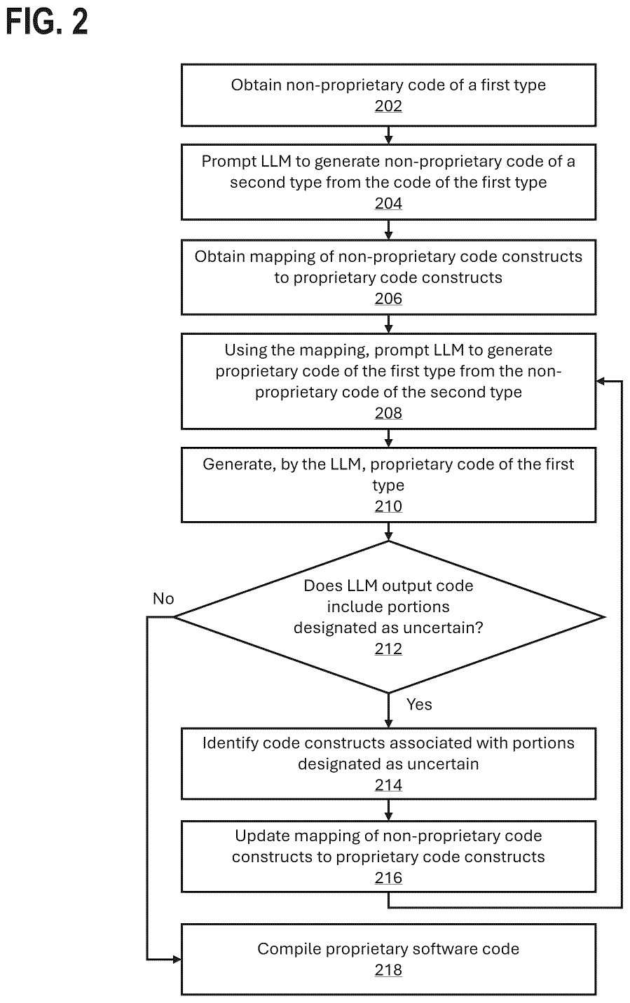

In one or more embodiments, the software code generation platform 120 refers to hardware and/or software configured to perform operations described herein for generating code, including pseudocode, non-proprietary software code, and proprietary software code, by engineering and providing input prompts to an LLM. Examples of operations for generating proprietary software code using an LLM are described below with reference to FIG. 2.

In an embodiment, the software code generation platform 120 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 126 refers to hardware and/or software configured to facilitate communications between a user and the software code generation platform 120. Interface 126 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 126 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 126 is specified in one or more other languages, such as Java, C, or C++.

### 4. Generating Software Code Using Large Language Models

FIG. 2 illustrates an example set of operations for generating proprietary software code using a large language model (LLM) that is trained to generate non-proprietary software code in accordance with one or more embodiments. One or more operations illustrated in FIG. 2 may be modified, rearranged, or omitted. Accordingly, the sequence of operations illustrated in FIG. 2 should not be construed as limiting the scope of one or more embodiments.

In an embodiment, the system obtains non-proprietary code of a first type (Operation 202). The type of code may be either pseudocode or software code. As referred to herein, pseudocode is a high-level description of a computer algorithm that uses natural language to outline the steps of the algorithm. The pseudocode is not tied to any specific programming language syntax. As a result, the pseudocode allows programmers to design and plan algorithms in a human-readable format before translating them into actual code. In some embodiments, pseudocode includes comments to explain steps and constructs included in the pseudocode. As referred to herein, software code includes code written in a programming language that may be compiled to generate executable software artifacts and programs. Examples of software code include JAVA, PYTHON, and C++.

In addition, as referred to herein, proprietary code is code that adheres to a set of proprietary rules, restrictions, and/or conventions for generating and modifying code constructs. The proprietary rules are in addition to any rules that define the underlying code. For example, a set of code, such as pseudocode or software code, may be written to adhere to a set of rules, including syntax and structural rules. Within those rules, a programmer may apply any name to a code construct, such as a variable or a function. However, the proprietary rules may impose further restrictions on names for code constructs, such as requiring the name to include specified characters, be of a specified length, or include specified patterns of letters and numbers. While both non-proprietary and proprietary code may be a basis for a successfully compiled executable software artifact, only the code that complies with the proprietary rules meets proprietary criteria and therefore qualifies as proprietary code.

In one embodiment, the system obtains the non-proprietary code of the first type from a data storage device based on a user generating and storing the non-proprietary code. In another embodiment, the non-proprietary code is generated by the LLM, or another LLM, based on a prompt. For example, a user may provide to the LLM a natural-language prompt to generate a set of code corresponding to a particular code construct. The resulting code is the non-proprietary code of the first type.

The system prompts the LLM to generate non-proprietary code of a second type from the non-proprietary code of the first type (Operation 204). In the example in which the non-proprietary code of the first type is software code, the system prompts the LLM to generate pseudocode based on the software code. In response to the prompt, the LLM generates a set of pseudocode that corresponds to the software code.

According to one example, the non-proprietary code of the first type is a set of code written in JAVA programming language. Based on an input prompt including the set of JAVA code and an instruction to convert the code into pseudocode, the LLM generates a corresponding set of pseudocode. As described above, the pseudocode is a high-level description of a computer algorithm. The JAVA code implements the computer algorithm according to the syntax and structure of the JAVA programming language. The pseudocode generated by the LLM specifies code constructs from the JAVA programming language in natural language and without adhering to JAVA programming syntax requirements.

The system obtains a proprietary code mapping of non-proprietary code constructs to proprietary code constructs (Operation 206). The proprietary code mapping may be a digitally stored file such as a table stored in a digital file. Code constructs include statements, functions, variables, operators, objects, properties, methods, and comments. For example, a set of pseudocode may correspond to a task that could be implemented using three different expression statements in the JAVA programming language, labeled here as ES1, ES2, and ES3. The proprietary code mapping may specify that ES1 and ES2 should be implemented in a form ES3. In other words, the proprietary code mapping directs an LLM to replace expression statements ES1 and ES2 in an LLM output for performing a task with the expression statement ES3 to perform the task.

Additionally, or alternatively, the proprietary code mapping may map code constructs in one code type with code constructs in another code type. For example, the proprietary code mapping may identify a particular if/and construct in pseudocode. The proprietary code mapping may specify a type of JAVA code construct, such as an expression statement in JAVA, that maps to the if/and pseudocode construct.

In one or more embodiments, the proprietary code mapping includes one-to-many mappings of one code construct of one type to multiple code constructs of a second type. The multiple code constructs may correspond to different programming languages. For example, the proprietary code mapping may specify a pseudocode construct that corresponds to a first JAVA code construct, a second PYTHON code construct, and a third C++ code construct. Alternatively, the system may store different mappings for different programming languages.

In one or more embodiments, the system obtains the proprietary code mapping based on detecting trigger language in an LLM prompt. The trigger language may indicate that a user requests the LLM to generate code that meets proprietary criteria. According to one example embodiment, a system includes an LLM interface engine that receives and analyzes requests directed to an LLM, including user-generated LLM prompts. The LLM interface engine supplements the content in the user-generated requests with additional data to generate a modified LLM prompt to provide to an LLM. As an example, the system may receive the following user-generated LLM prompt: “Generate a set of PYTHON code based on the attached set of pseudocode. The PYTHON code should comply with ABC Co. programming requirements.” The system analyzes the user-generated LLM prompt to identify the following elements: (a) a request of a function to be performed (“Generate a set of PYTHON code”), (b) a target object (“based on the attached set of pseudocode”), and (c) a proprietary identifier (“The PYTHON code should comply with ABC Co. programming requirements”). In the above example, a user attaches a set of pseudocode to the LLM prompt. However, the LLM prompt does not specify the ABC Co. programming requirements. The LLM interface engine identifies the proprietary identifier in the preliminary prompt, retrieves a proprietary code mapping specifying the ABC Co. programming requirements, and generates a modified LLM prompt that includes the proprietary code mapping. The modified prompt may state, for example, “The PYTHON code should comply with the ABC Co. programming requirements in the attached mapping file.”

According to one example embodiment, the system stores one or more mappings corresponding to one or more programming languages and retrieves the proprietary code mappings based on detecting a proprietary identifier in a preliminary prompt without any intervening user input. Additionally, or alternatively, the system may request a proprietary code mapping from a user. For example, the system may identify a proprietary identifier in the preliminary prompt. If a proprietary mapping that corresponds to the proprietary identifier is not found in a proprietary mapping repository, the system may generate a message to request that the user provide the proprietary code mapping. According to another example, upon retrieving a proprietary code mapping from a proprietary mapping repository, the system may generate a message asking a user to confirm that the proprietary code mapping is correct and/or if the user would like to modify the proprietary code mapping prior to providing the proprietary code mapping to the LLM in a modified LLM prompt.

The system generates an LLM prompt using the proprietary code mapping and the set of input code of the first type (Operation 208). As discussed above, according to one example embodiment, a system includes an LLM interface engine that receives and analyzes requests, including preliminary prompts, and supplements the requests with data to generate a final LLM prompt to provide to an LLM. According to one example, based on detecting a proprietary identifier in an LLM prompt, the system determines if the request includes a proprietary mapping corresponding to the proprietary identifier. If so, the system passes the LLM prompt to the LLM. If the proprietary code mapping is not included in the prompt, the system searches for the proprietary code mapping and attaches the proprietary code mapping to a modified LLM prompt.

The system may generate the LLM prompt based on multiple different types of input. For example, a user may provide a natural language LLM prompt. The system may modify the user's prompt or transmit the prompt directly to the LLM. Alternatively, the system may generate the LLM prompt. For example, a user may provide the system with a set of natural language requirements, such as “Generate a set of JAVA code that performs operations A, B, and C, and returns a set of values D1-Dn.” The system may convert the user-provided natural language requirements into one or more LLM prompts. According to one example, the system generates a first prompt to direct an LLM to generate a set of non-proprietary JAVA code. The system then generates a second prompt to direct the LLM to convert the non-proprietary JAVA code into pseudocode. The system then generates a third prompt to direct the LLM to convert the pseudocode into proprietary JAVA code.

In one or more embodiments, the system applies a set of LLM prompt generation rules to a set of natural language user instructions to generate the LLM prompts. The LLM prompt generation rules include criteria for structuring the LLM prompt, including specifying instructions to include in the LLM prompt. For example, a set of rules may specify vocabulary for the system to use to direct the LLM to perform targeted actions. Examples of vocabulary for directing the LLM to perform targeted actions include “generate code,” “annotate,” “format,” and “extract.” The set of rules may further specify vocabulary for the system to use to direct the LLM to generate content of a particular type. Examples include “PYTHON code,” “JAVA code,” and “pseudocode.” The set of rules may further specify language for the system to include in a prompt that directs the LLM to express uncertainty when the LLM determines it has not been trained to generate a particular output or that the training dataset included too few examples to provide a high degree of uncertainty. Examples of instructions to include in the prompt to direct the LLM to express uncertainty include “include a confidence value between 1 and 10 for each JAVA code construct in the output JAVA code,” and “if an output JAVA code construct corresponding to an input pseudocode construct cannot be determined, leave the pseudocode construct among the output set of JAVA code.”

The LLM generates a set of proprietary output code of the first type (Operation 210). In an example in which the second code type is pseudocode and the first code type is software code, the LLM generates a set of proprietary software code based on (a) the pseudocode and (b) the proprietary code mapping. A set of proprietary code may include both proprietary and non-proprietary code constructs. For example, a set of proprietary rules may not include rules for generating every possible software code construct in a programming language. For code constructs that are included in the proprietary code mapping, the LLM generates proprietary software code constructs. For code constructs that are not included in the proprietary code mapping, the LLM generates software code constructs based on its training dataset.

For example, an LLM is trained on a non-proprietary training dataset. If no mapping is provided to the LLM, the LLM generates non-proprietary output code. The system may receive as input code a set of pseudocode including two pseudocode constructs such as pseudocode describing two functions to be performed. The system identifies a first pseudocode construct in the proprietary code mapping that is mapped to a first proprietary software code construct. The system determines the second pseudocode construct is not included in the proprietary code mapping. Based on determining a first pseudocode construct is mapped to the first proprietary software code construct in the proprietary code mapping, the LLM generates a first set of output software code, including the proprietary software code construct. Based on determining a second pseudocode construct is not mapped to any proprietary software code construct in the proprietary code mapping, the LLM generates a second set of output software code without relying on the proprietary code mapping. Since the LLM is trained to generate non-proprietary software code, the second set of output software code is not required to conform to any proprietary rules or criteria. Since every set of output software code that is required to conform to proprietary rules does comply with the proprietary rules, the set of output software code qualifies as proprietary software code.

The system determines if the proprietary code of the first type output by the LLM includes one or more portions designated as uncertain (Operation 212). For example, when the system provides the LLM with the prompt to generate proprietary code of the first type as output code, the prompt may include an instruction directing the LLM to not guess when generating the output code. If an LLM is trained on a dataset that includes a few or no examples of a particular code construct, the LLM may be poorly trained to generate the code construct, resulting in errors in the code generated by the LLM. If the LLM receives an instruction to generate a code construct for which it is untrained or poorly trained, the LLM may, by default, “guess” at generating an output code construct. In other words, the LLM generates a code construct that, based on the LLM parameters determined during training the LLM, it determines is most likely to correspond to the requested code construct. These attempts are frequently wrong, resulting in errors at compile-time or run-time. In one or more embodiments, a system may include in the LLM prompt an instruction to not guess at code constructs that the LLM does not know. Examples of such instructions include an express instruction telling the LLM to express uncertainty, an instruction directing the LLM to generate confidence scores for its code constructs, and an instruction to pass input code data through to output code data without generating a set of output code of the first type based on the input code of the second type.

According to one example, determining if the output code includes a portion designated as uncertain includes identifying in the output code a comment that expressly indicates the LLM is uncertain of the output code construct. According to another example, determining if the output code includes a portion designated as uncertain includes identifying in the output code a comment including a confidence value, such as a value between 0 and 1, or between 1 and 10. According to yet another example, determining if the output code includes a portion designated as uncertain includes identifying in a set of output software code a portion that the LLM left in pseudocode. Another example of an indication of uncertainty may include color-coding. For example, a code construct highlighted or displayed with red text may indicate a high level of uncertainty by the LLM. According to one example, a determination of uncertainty includes comparing a confidence level generated by the LLM with a threshold. For example, the LLM prompt may include an instruction to generate an indication of uncertainty for any code construct corresponding to a confidence level less than 7 on a scale of 1-10.

The system identifies code constructs of the first type that correspond to the portions of the output code the LLM has designated as “uncertain” (Operation 214). Identifying code constructs corresponding to “uncertain” portions of output code may include, for example, obtaining user input. In one example, the system generates a request to a user to review any portions of output code designated as “uncertain” by the LLM. The system may request that the user provide an example code construct for the LLM. Additionally, or alternatively, a user may indicate that the code construct identified as “uncertain” by the LLM is an acceptable code construct for the LLM to generate.

Based on identifying code constructs of the first type that correspond to the portions of the output code identified as “uncertain,” the system updates the proprietary code mapping to include the code constructs of the first type (Operation 216). According to one example, the system includes in the proprietary code mapping a new mapping that maps (a) a code construct identified as “uncertain” by the LLM and (b) an example code construct provided by the user. In an example in which the proprietary code mapping maps pseudocode constructs to software code constructs, the system identifies a set of pseudocode corresponding to the portion of the output code identified as “uncertain.” The system generates a proprietary code mapping of the set of pseudocode to the example software code construct obtained from a user. Alternatively, if the user indicated a software code construct that was identified as “uncertain” was an acceptable software code construct, the system may generate a proprietary code mapping of pseudocode to the acceptable software code construct. According to yet another example, if the user indicated a software code construct that was identified as “uncertain” was an acceptable software code construct, the system may generate an instruction to the LLM to modify its confidence level associated with the acceptable software code construct such that it exceeds an uncertainty threshold.

In an example in which the proprietary code mapping maps non-proprietary software code constructs to proprietary software code constructs, the system identifies a non-proprietary software code construct corresponding to the portion of the output code identified as “uncertain.” The system generates a proprietary code mapping of the non-proprietary software code construct to the example proprietary software code construct obtained from a user. Alternatively, if the user indicated a software code construct that was identified as “uncertain” was an acceptable software code construct, the system may generate an instruction to the LLM to modify its confidence level associated with the acceptable software code construct such that it exceeds an uncertainty threshold.

In one or more embodiments, the indication of uncertainty and the subsequent modification of the proprietary code mapping provides a feedback mechanism to iteratively update the proprietary mapping and the corresponding LLM prompts. When the system identifies input code constructs that the LLM was unable to convert into output code constructs, the system (a) identifies output code constructs that correspond to the input code constructs and (b) updates the proprietary code mapping provided to the LLM as input prompt data. Additionally, or alternatively, the system may identify one or more new proprietary rules for the LLM to apply to generate proprietary code.

In an embodiment in which the output code generated by the LLM is software code, the system compiles the proprietary software code to generate machine code based on determining the output code generated by the LLM does not include portions designated as “uncertain” (Operation 218).

In the example illustrated in FIG. 2, a system obtains a proprietary code mapping of non-proprietary code constructs to code constructs to instruct an LLM to generate proprietary code. Additionally, the system may obtain a set of proprietary rules that may be applied to multiple different code constructs. For example, a set of proprietary rules may specify naming conventions for naming variables, syntax requirements for including syntax in code, and comment requirements for providing non-compiled explanations of code segments throughout the output code. These rules may be applicable to specific subsets of proprietary code constructs or to all proprietary code constructs.

### 5. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

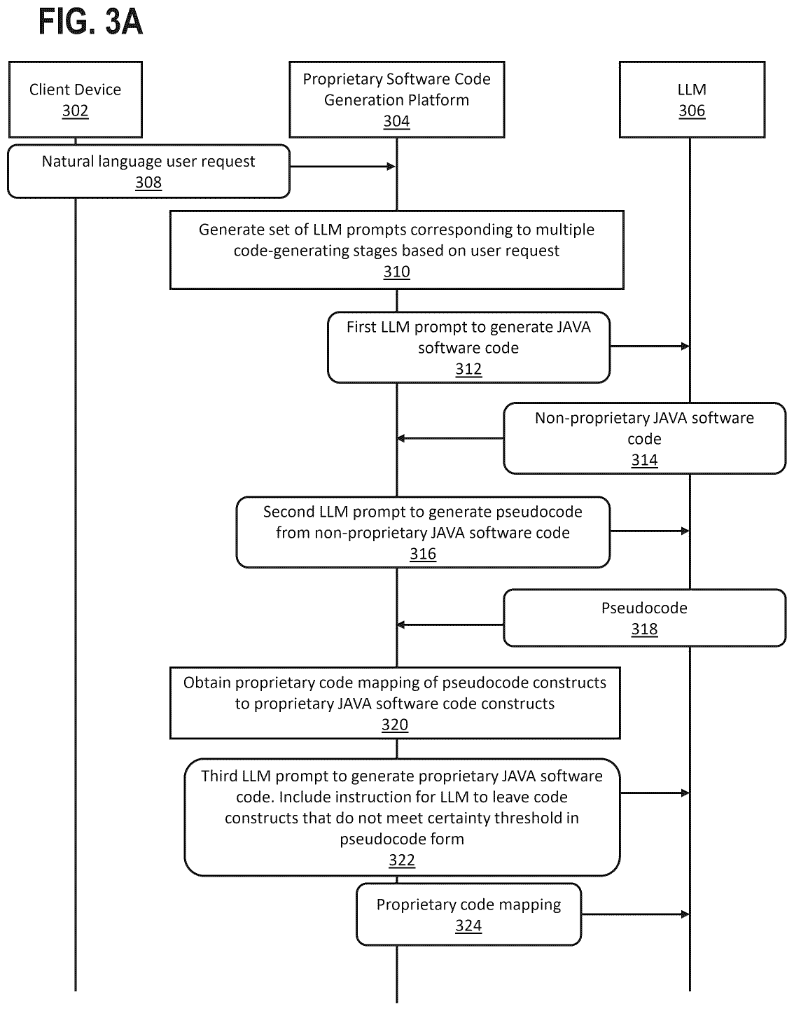

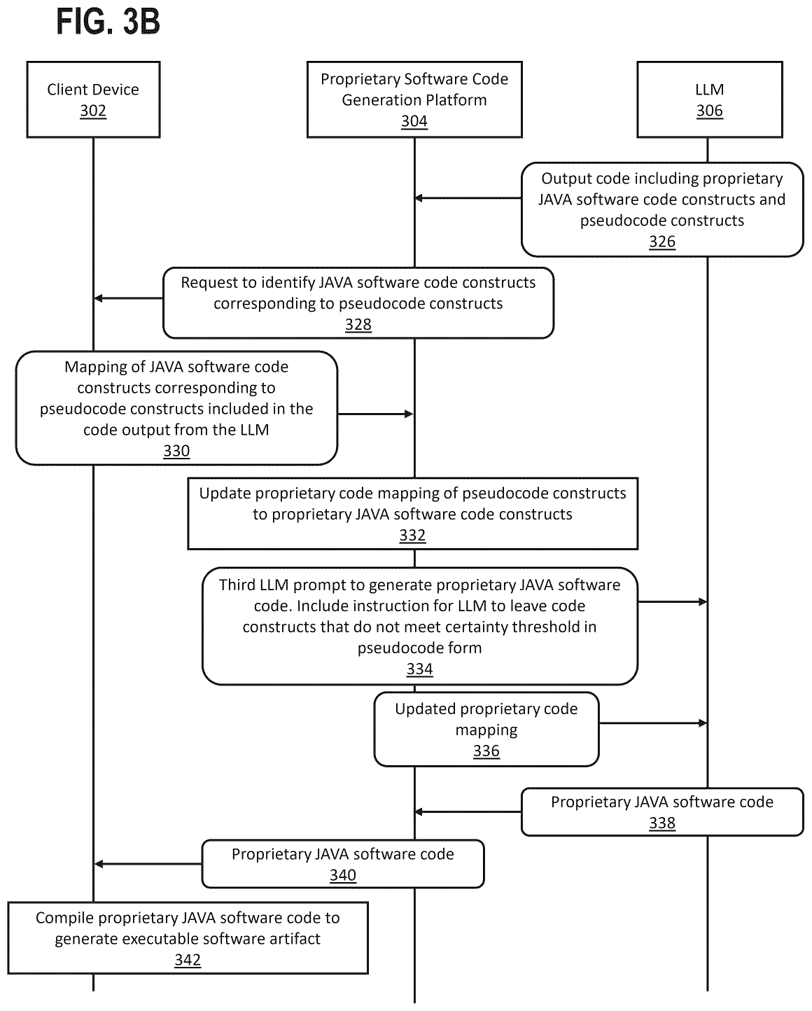

FIGS. 3A and 3B illustrate a system and process for generating proprietary software code from a natural language user instruction and an LLM trained to generate non-proprietary code. The system includes a client device 302, a proprietary software code generation platform 304, and an LLM 306. Referring to FIG. 3A, the proprietary software code generation platform 304 receives a natural language user request 308 to generate a set of software code. For example, the request may include the following: “Write me a code to merge two map objects and sort the final map by the creation date of each entry in the map using JAVA.”

Based on the received request, the proprietary software code generation platform 304 generates a set of LLM prompts corresponding to multiple code-generating stages (Operation 310). The proprietary software code generation platform 304 determines that the user associated with the client device 302 is associated with a particular entity (e.g., ABC Co.). The proprietary software code generation platform 304 further determines that ABC Co. requires that any code that is generated adheres to a set of proprietary code-generation rules. These include rules specifying a software code construct to use to perform a function, from among a set of multiple software code constructs that could be used to perform the function. The rules further specify naming conventions for naming data objects, syntax conventions for structuring software code, and commenting conventions for including comments in software code. The proprietary software code generation platform 304 generates the set of LLM prompts based on determining that the code is required to adhere to a set of proprietary rules.

A first prompt includes instructions to the LLM 306 to generate JAVA software code. For example, the proprietary software code generation platform 304 may convert the user request into the following: “Generate JAVA software code that performs the following functions: (a) merge two map objects, (b) sort the final map, generated by merging the two map objects, by the creation date of each entry in the map.” A second prompt includes instructions to the LLM 306 to generate pseudocode from the JAVA software code. A third prompt includes instructions to the LLM 306 to generate proprietary software code from the pseudocode. The third prompt includes a proprietary code mapping to instruct the LLM to use proprietary JAVA software code constructs instead of non-proprietary JAVA software code constructs in any software code generated by the LLM 306 associated with ABC Co.

The proprietary software code generation platform 304 provides the first prompt to the LLM 306 (Operation 312). For example, the proprietary software code generation platform 304 may interface with the application programming interface (API) of the LLM 306 to provide the prompt text to the LLM 306.

The LLM 306 generates a set of JAVA software code 314 based on the prompt and provides the JAVA software code to the proprietary software code generation platform 304. The LLM 306 is trained to generate non-proprietary software code. Entities, such as companies, organizations, and software programming teams, may maintain proprietary software code generating rules to maintain consistency within the entity, to ensure defined quality specifications are met, to ensure compatibility with applications used by the entity, or for any other reason. LLMs, including the LLM 306, are trained on billions of words, text segments, programming code segments, and pseudocode segments. Proprietary code is generally not included in LLM training data. Even in cases in which proprietary code is included in the LLM training data, the volume of proprietary code is miniscule compared to the volume of non-proprietary code. Accordingly, the LLM 306 is not trained to generated the proprietary code. Therefore, the JAVA software code 314 generated by the LLM 306 is non-proprietary code that does not adhere to any set of proprietary code-generation rules.

The proprietary software code generation platform 304 generates a second LLM prompt 316 instructing the LLM 306 to generate non-proprietary pseudocode. The pseudocode is not tied to any specific programming language syntax. Instead, the pseudocode describes the non-proprietary JAVA software code at a high level and in a human-readable format.

The LLM 306 generates the pseudocode 318 and transmits the pseudocode to the proprietary software code generation platform 304.

The proprietary software code generation platform 304 obtains a proprietary code mapping of pseudocode constructs to proprietary JAVA proprietary code constructs for ABC Co. (Operation 320). The proprietary code mapping is a digitally stored file. The proprietary code mapping includes a table that maps pseudocode constructs to proprietary JAVA software code constructs. The proprietary JAVA software code constructs include statements, functions, variables, operators, objects, properties, methods, and comments.

The proprietary software code generation platform 304 generates the third LLM prompt 322 using the proprietary code mapping 324 and the pseudocode. The third LLM prompt 322 includes an instruction for the LLM to leave code constructs that do not meet a certainty threshold in pseudocode form. The proprietary software code generation platform 304 transmits the third prompt to the LLM 306.

Referring to FIG. 3B, the LLM 306 generates a set of output code 326 that includes (a) proprietary JAVA software code constructs and pseudocode constructs. As discussed above, the LLM is trained to generate non-proprietary JAVA software code. For any pseudocode construct included in the proprietary code mapping, the LLM 306 generates the corresponding proprietary code construct in the output code. For any pseudocode construct that is not included in the proprietary code mapping, the LLM 306 generates the a non-proprietary code construct based on its training. For any pseudocode construct or software code construct that the LLM determines is associated with a confidence level less than a threshold level, the LLM 306 includes the pseudocode in the output code. Accordingly, the output code 326 includes both software code constructs and pseudocode constructs.

The proprietary software code generation platform 304 identifies the pseudocode constructs in the output code 326. The proprietary software code generation platform 304 generates a request 328 to the client 302 to identify JAVA software code constructs corresponding to the pseudocode constructs. The request 328 includes at least one JAVA software code construct identified by the LLM 306 as being its “best guess” of the software code construct that corresponds to the pseudocode construct.

The proprietary software code generation platform 304 receives a mapping of JAVA software code constructs from the client device 302. For example, a user operating the client device 302 may review any pseudocode constructs to identify corresponding JAVA software code constructs.

Based on mapping 330 obtained from the client device 302, the proprietary software code generation platform 304 updates the proprietary code mapping of pseudocode constructs to JAVA software code constructs (Operation 332). When updating the mapping, the proprietary software code generation platform 304 may analyze software code constructs received from the client device 302 for any errors. For example, the proprietary software code generation platform 304 may identify incorrect syntax. Additionally, or alternatively, the proprietary software code generation platform 304 may determine that the software code construct obtained from the client device 302 would not perform the function corresponding to the pseudocode. If an error is detected, the proprietary software code generation platform 304 may generate a notification to, or request for further information from, the client device 302.

The proprietary software code generation platform 304 re-sends the third LLM prompt (labeled in FIG. 3B as reference numeral 334) to the LLM with the updated proprietary code mapping 336. The LLM 306 generates a set of proprietary JAVA software code 338 and transmits the proprietary JAVA software code 338 to the proprietary software code generation platform 304. For any pseudocode construct included in the proprietary code mapping, the LLM 306 generates the corresponding proprietary code construct in the output code. For any pseudocode construct that is not included in the proprietary code mapping, the LLM 306 generates the a non-proprietary code construct based on its training. Accordingly, the proprietary JAVA software code 338 may include both proprietary code constructs specified in the proprietary code mapping 336 and non-proprietary code constructs. A set of code that is determined to comply with any proprietary code rules and that includes any required proprietary code constructs qualifies as proprietary software code.

The proprietary software code generation platform 304 sends the proprietary JAVA software code 340 to the client 302 in response to the request 308. In FIG. 3B, the reference numeral 340 is used to differentiate the proprietary JAVA software code sent from the proprietary software code generation platform 304 and the proprietary JAVA software code sent from the LLM 306. However, the proprietary JAVA software code 338 and 340 may be the same code.

The client 302 compiles the proprietary JAVA software code to generate an executable software artifact 342. Additionally, or alternatively, a user may further view and modify the proprietary JAVA software code 340 in the client device 302.

In one or more embodiments, a system may use a same set of pseudocode to generate different sets of proprietary software code in different programming languages and using different proprietary rules. For example, a system may receive a first instruction to convert a set of pseudocode into a first proprietary JAVA code using a first proprietary code mapping. The system may receive a second instruction to convert the same set of pseudocode into a second proprietary JAVA code using a second proprietary code mapping. The resulting first set of proprietary JAVA software code may be different from the resulting second set of proprietary JAVA software code. In addition, the system may receive a third instruction to convert the same set of pseudocode into a proprietary PYTHON code using a third proprietary code mapping. Accordingly, a single LLM trained to generated non-proprietary software code may be used to generate different sets of proprietary software code in different programming languages using different LLM prompts and proprietary code mappings.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

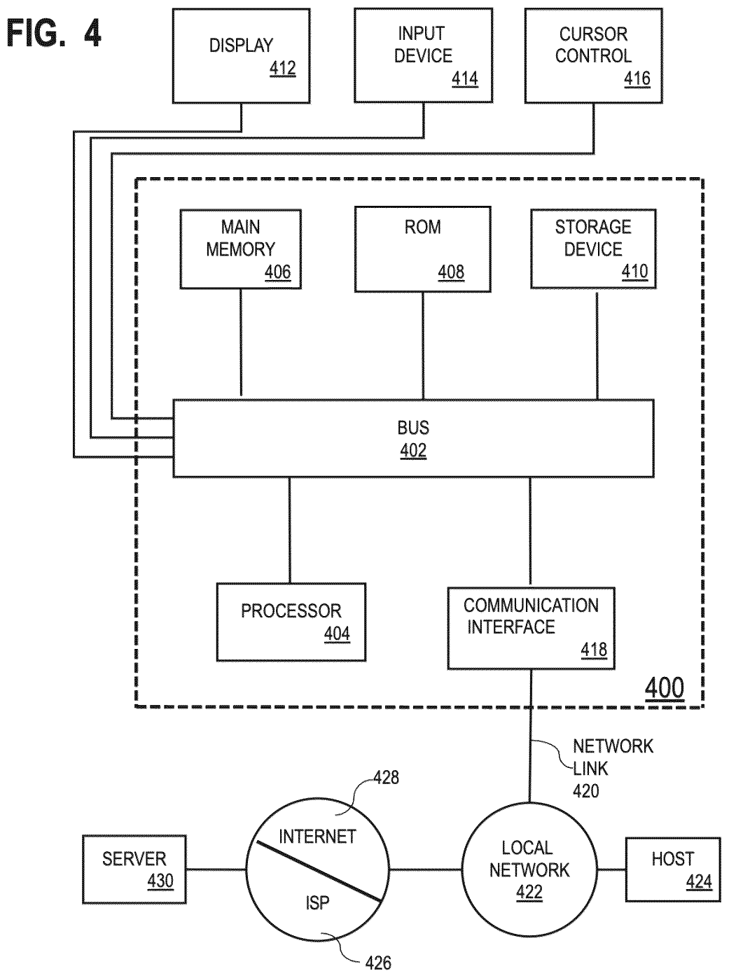

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid-State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
accessing a first mapping of pseudocode constructs to proprietary software code constructs;
receiving a request to generate a first set of proprietary software code based on a first set of pseudocode;
based on the request, generating a set of instructions for a trained large language model (LLM) to generate a first set of proprietary software code based on (a) the first set of pseudocode and (b) the first mapping of pseudocode constructs to proprietary software code constructs; and
inputting the set of instructions to the trained LLM to generate the first set of proprietary software code,
wherein the proprietary software code constructs are determined by the trained LLM based on the first mapping of pseudocode constructs to proprietary software code constructs.

2. The non-transitory computer readable media of claim 1, wherein the set of instructions further comprises an instruction to the LLM to refrain from guessing, and
wherein the operation comprise:
based on the instruction to refrain from guessing, generating, by the LLM, the first set of proprietary software code including an indication of uncertainty corresponding to at least one software code construct.

3. The non-transitory computer readable media of claim 2, wherein the indication of uncertainty includes at least one of:
including in the first set of proprietary software code a first pseudocode construct;
presenting one or more confidence level values corresponding to one or more software code constructs included in the first set of proprietary software code;
presenting one or more express statements of uncertainty corresponding to the one or more software code constructs included in the first set of proprietary software code.

4. The non-transitory computer readable media of claim 2, wherein the operations further comprise:
detecting in the first set of proprietary software code a first indication of uncertainty associated with a first software code construct;
identifying a second proprietary software code construct corresponding to the first software code construct;
generating a second mapping at least by: updating the first mapping to map the second proprietary software code construct to the first software code construct; and
re-applying the LLM to the set of pseudocode and the second mapping to generate a second set of proprietary software code, wherein the second set of proprietary software code includes the second proprietary software code construct.

5. The non-transitory computer readable media of claim 2, wherein generating the first set of proprietary software code including the indication of uncertainty comprises:
determining, by the LLM, that a first certainty level corresponding to a first set of software code constructs meets a threshold certainty level;
based on determining the first certainty level meets the threshold certainty level: including the first set of software code constructs in the proprietary software code;
determining, by the LLM, that a second certainty level corresponding to a second set of software code constructs does not meet the threshold certainty level; and
based on determining the second certainty level does not meet the threshold certainty level: including a first set of pseudocode constructs, corresponding to the second set of software code constructs, in the proprietary software code.

6. The non-transitory computer readable media of claim 1, wherein the request comprises a first set of human-understandable requirements,
wherein the operations further comprise:
applying the LLM to the first set of human-understandable requirements to generate a first set of non-proprietary software code; and
applying the LLM to the first set of non-proprietary software code to generate the first set of pseudocode based on the first set of non-proprietary software code.

7. The non-transitory computer readable media of claim 6, wherein the operations further comprise:
determining the request is associated with a first set of proprietary code requirements;
wherein accessing the first mapping of pseudocode constructs to proprietary software code constructs is performed based on determining the first mapping corresponds to the first set of proprietary code requirements.

8. A method comprising:
accessing a first mapping of pseudocode constructs to proprietary software code constructs;
receiving a request to generate a first set of proprietary software code based on a first set of pseudocode;
based on the request, generating a set of instructions for a trained large language model (LLM) to generate a first set of proprietary software code based on (a) the first set of pseudocode and (b) the first mapping of pseudocode constructs to proprietary software code constructs; and
inputting the set of instructions to the trained LLM to generate the first set of proprietary software code,
wherein the proprietary software code constructs are determined by the trained LLM based on the first mapping of pseudocode constructs to proprietary software code constructs.

9. The method of claim 8, wherein the set of instructions further comprises an instruction to the LLM to refrain from guessing,
wherein the method further comprises:
based on the instruction to refrain from guessing, generating, by the LLM, the first set of proprietary software code including an indication of uncertainty corresponding to at least one software code construct.

10. The method of claim 9, wherein the indication of uncertainty includes at least one of:
including in the first set of proprietary software code a first pseudocode construct;
presenting one or more confidence level values corresponding to one or more software code constructs included in the first set of proprietary software code;
presenting one or more express statements of uncertainty corresponding to the one or more software code constructs included in the first set of proprietary software code.

11. The method of claim 9, further comprising:
detecting in the first set of proprietary software code a first indication of uncertainty associated with a first software code construct;
identifying a second proprietary software code construct corresponding to the first software code construct;
generating a second mapping at least by: updating the first mapping to map the second proprietary software code construct to the first software code construct; and
re-applying the LLM to the set of pseudocode and the second mapping to generate a second set of proprietary software code, wherein the second set of proprietary software code includes the second proprietary software code construct.

12. The method of claim 9, wherein generating the first set of proprietary software code including the indication of uncertainty comprises:
determining, by the LLM, that a first certainty level corresponding to a first set of software code constructs meets a threshold certainty level;
based on determining the first certainty level meets the threshold certainty level: including the first set of software code constructs in the proprietary software code;
determining, by the LLM, that a second certainty level corresponding to a second set of software code constructs does not meet the threshold certainty level; and
based on determining the second certainty level does not meet the threshold certainty level:
including a first set of pseudocode constructs, corresponding to the second set of software code constructs, in the proprietary software code.

13. The method of claim 8, wherein the request comprises a first set of human-understandable requirements,
wherein the method further comprises:
applying the LLM to the first set of human-understandable requirements to generate a first set of non-proprietary software code; and
applying the LLM to the first set of non-proprietary software code to generate the first set of pseudocode based on the first set of non-proprietary software code.

14. The method of claim 13, further comprising:
determining the request is associated with a first set of proprietary code requirements;
wherein accessing the first mapping of pseudocode constructs to proprietary software code constructs is performed based on determining the first mapping corresponds to the first set of proprietary code requirements.

15. A system, comprising:
at least one device including a hardware processor;
the system being configured to perform operations comprising:
accessing a first mapping of pseudocode constructs to proprietary software code constructs;
receiving a request to generate a first set of proprietary software code based on a first set of pseudocode;
based on the request, generating a set of instructions for a trained large language model (LLM) to generate a first set of proprietary software code based on (a) the first set of pseudocode and (b) the first mapping of pseudocode constructs to proprietary software code constructs; and
inputting the set of instructions to the trained LLM to generate the first set of proprietary software code,
wherein the proprietary software code constructs are determined by the trained LLM based on the first mapping of pseudocode constructs to proprietary software code constructs.

16. The system of claim 15, wherein the set of instructions further comprises an instruction to the LLM to refrain from guessing,
wherein the operations further comprise:
based on the instruction to refrain from guessing, generating, by the LLM, the first set of proprietary software code including an indication of uncertainty corresponding to at least one software code construct.

17. The system of claim 16, wherein the indication of uncertainty includes at least one of:
including in the first set of proprietary software code a first pseudocode construct;
presenting one or more confidence level values corresponding to one or more software code constructs included in the first set of proprietary software code;
presenting one or more express statements of uncertainty corresponding to the one or more software code constructs included in the first set of proprietary software code.

18. The system of claim 16, further comprising:
detecting in the first set of proprietary software code a first indication of uncertainty associated with a first software code construct;
identifying a second proprietary software code construct corresponding to the first software code construct;
generating a second mapping at least by: updating the first mapping to map the second proprietary software code construct to the first software code construct; and
re-applying the LLM to the set of pseudocode and the second mapping to generate a second set of proprietary software code, wherein the second set of proprietary software code includes the second proprietary software code construct.

19. The system of claim 16, wherein generating the first set of proprietary software code including the indication of uncertainty comprises:
determining, by the LLM, that a first certainty level corresponding to a first set of software code constructs meets a threshold certainty level;
based on determining the first certainty level meets the threshold certainty level: including the first set of software code constructs in the proprietary software code;
determining, by the LLM, that a second certainty level corresponding to a second set of software code constructs does not meet the threshold certainty level; and
based on determining the second certainty level does not meet the threshold certainty level:
including a first set of pseudocode constructs, corresponding to the second set of software code constructs, in the proprietary software code.

20. The system of claim 15, wherein the request comprises a first set of human-understandable requirements,
wherein the operations further comprise:
applying the LLM to the first set of human-understandable requirements to generate a first set of non-proprietary software code; and
applying the LLM to the first set of non-proprietary software code to generate the first set of pseudocode based on the first set of non-proprietary software code.
